(19) United States
(12) Patent Application Publication
(10) Pub. No.: US 2026/0066726 A1
(43) Pub. Date: Mar. 5, 2026

(54) EMOTOR/GENERATOR ROTOR MOUNTING ARRANGEMENT

(71) Applicant: Schaeffler Technologies AG & Co. KG, Herzogenaurach (DE)

(72) Inventors: Matthew Payne, Glenmont, OH (US); Noah Kee, Rittman, OH (US); Jai Patel, Wooster, OH (US)

(73) Assignee: Schaeffler Technologies AG & Co. KG, Herzogenaurach (DE)

(21) Appl. No.: 18/816,301

(22) Filed: Aug. 27, 2024

(51) Int. Cl. H02K 1/30; F02N 11/00; H02K 7/075; H02K 21/14

(52) U.S. Cl. CPC H02K 1/30; F02N 11/00; H02K 7/075; H02K 21/14

(57) ABSTRACT

An emotor mounting arrangement for an internal combustion engine is provided, including an emotor having a rotor that is rotatably mounted and a stator that is fixed relative to the engine. A hub is connected to the rotor, with the hub including a pilot extension that is adapted to be supported in an end of a crankshaft of the internal combustion engine. A drive plate is connected to and extends radially from the hub, and the drive plate includes connector openings that are adapted for connecting the drive plate to a flex plate connected to the crankshaft. The hub can b integrally formed with a rotor carrier, or the hub can be assembled from stamped sheet metal parts.

### FIELD OF INVENTION

The disclosure relates to an emotor/generator mounting arrangement to an internal combustion engine. More specifically, it relates to centering and mounting of the electric motor/generator rotor.

### BACKGROUND

For generators, as well as other drive arrangements, an emotor (which can act as a motor and/or generator) is connected to an internal combustion engine (ICE) with the rotor engaged with the crankshaft, and torque from the ICE is transmitted to the rotor to generate electricity. The emotor may also be used in a motor mode, for example as part of a hybrid drive arrangement, and transfer torque to the crankshaft and/or a downstream transmission.

It would be desirable to find a cost-effective solution to supporting the rotor and for transferring torque to and/or from a crankshaft of the ICE to the rotor.

### SUMMARY

In one aspect, an emotor mounting arrangement to an internal combustion engine is provided, with the emotor mounting arrangement including an emotor having a rotor that is rotatably mounted and a stator that is fixed relative to the engine. A hub is connected to the rotor, with the hub including a pilot extension that is adapted to be supported in an end of a crankshaft of the internal combustion engine. A drive plate is connected to and extends radially from the hub, and the drive plate includes connector openings that are adapted for connecting the drive plate to a flex plate connected to the crankshaft.

This arrangement allows for ease of mounting between the emotor and engine and aligns more closely with the typical architecture of an automatic transmission and torque converter setup, where fasteners can be inserted via an access opening, such as a starter motor pocket in the engine block, or an access opening that can extend through the generator housing.

In one embodiment, the drive plate is a stamped sheet metal part and is bolted to the hub. This reduces manufacturing costs. However, it could also be a machined part.

In another embodiment, the hub is a cast metal part. The cast metal part can be machined at interfaces with other parts, as needed. It can also be integrally formed with the rotor carrier.

In one embodiment, the connector openings in the drive plate are threaded and are adapted to receive fasteners that are inserted through corresponding openings in the flex plate. The fasteners can be inserted through the starter motor pocket or another access opening.

In one embodiment, the arrangement includes an emotor housing which receives the stator and the rotor. A front cover encloses a front of the emotor housing (which faces the engine) and includes an opening through which a front portion of the hub extends. The front portion of the hub includes a circumferentially extending outer surface, and a seal is located between the front cover and the circumferentially extending outer surface. The seal can be mounted to the front cover and can be a lip seal.

In one embodiment which is designed to reduce costs, the hub includes a stamped sheet metal cup that is connected to a rotor carrier, for example by welding. A plurality of circumferentially spaced stud openings are provided through an end wall of the stamped cup, and studs extend through the stud openings with a threaded end of each of the studs extending out from the stud openings. A central opening is located through the end wall, and a front part of the hub having the pilot extension extends through the central opening.

Here, the studs may each include a head that is located inside the stamped sheet metal cup. This allows the studs to be pressed in place with a press-fit so that they are held in place and uniformly aligned and seated. It would also be possible to weld the studs to the stamped sheet metal cup.

In one embodiment, the drive plate is fastened to the hub via the studs.

The front part of the hub having pilot extension can be cold formed as a separate part and press-fit into the central opening of the stamped sheet metal cup.

In one embodiment, an emotor housing is provided which receives the stator and the rotor. A front cover encloses a front of the emotor housing and includes an opening through which the front part of the hub with the pilot extension extends. The front part of the hub includes a circumferentially extending outer surface, and a seal is located between the front cover and the circumferentially extending outer surface. This seal can be a lip seal.

In another aspect, a method of connecting an emotor to an internal combustion engine is provided. Here, the engine has a crankshaft with a piloting bore in an end thereof and a flex plate connected to the crankshaft at the end. The method includes a) providing an emotor having a rotor that is rotatably mounted and a stator that is adapted to be fixed relative to the engine; b) inserting a pilot extension of a hub connected to the rotor into the piloting bore; c) aligning connector openings of a drive plate connected to and extending radially from the hub with corresponding openings in the flex plate; and d) installing fasteners in the connector openings and corresponding openings to connect the drive plate to the flex plate.

In one embodiment, the emotor includes an emotor housing which receives the stator and the rotor, and a front cover that encloses a front of the emotor housing and includes an opening through which a front portion of the hub extends. The front portion of the hub includes a circumferentially extending outer surface, and the method further includes installing a seal between the front cover and the circumferentially extending outer surface. This seal limits/prevents the loss of transmission fluid/coolant.

The method can further include connecting the emotor housing to a block of the engine, for example with bolts.

In one embodiment, the connector openings in the drive plate are threaded, and the method includes inserting the fasteners through the corresponding openings in the flex plate and threadedly engaging the fasteners in the threaded connector openings in the drive plate. The fasteners can be inserted through the starter motor pocket or another access opening.

In one embodiment, the method further includes forming the hub from a stamped sheet metal cup that is connected to a rotor carrier for the rotor, and including a plurality of circumferentially spaced stud openings through an end wall of the stamped cup, having studs that extend through the stud openings with a threaded end of each of the studs extending out from the stud openings, and a central opening through the end wall, with a front part of the hub having the pilot extension extending through the central opening, and the drive plate being fastened to the hub via the studs.

Here, the emotor can also include an emotor housing which receives the stator and the rotor, and a front cover that encloses a front of the emotor housing and includes an opening through which the front part of the hub extends, and the front part of the hub includes a circumferentially extending outer surface. The method can further include installing a seal between the front cover and the circumferentially extending outer surface.

Various features of the invention can be used alone or in combination in order to achieve one or more of the benefits described herein.

### BRIEF DESCRIPTION OF THE DRAWINGS

The foregoing Summary and the following detailed description will be better understood when read in conjunction with the appended drawings, which illustrate preferred embodiments according to the disclosure. In the drawings:

FIG. 1 is a cross-sectional view through an emotor mounting arrangement for an internal combustion engine showing a first embodiment of a hub having a piloting extension that is received in a piloting bore in an end of the crankshaft of the engine.

FIG. 2 is a partial view taken at lines 2-2 in FIG. 1 to show a starter motor pocket or other access opening for installing fasteners to connect the flex plate to the drive plate.

FIG. 3 is a cross-sectional view through an emotor mounting arrangement in accordance with a second embodiment of the present disclosure showing an alternate construction of the hub which supports the rotor of the emotor.

FIG. 4 is a detailed view showing a stud used in the alternate hub shown in FIG. 3.

FIG. 5 is an end view of the stud shown in FIG. 3 taken along lines 4-4 in FIG. 4.

### DETAILED DESCRIPTION

Certain terminology is used in the following description for convenience only and is not limiting. The words “inwardly” and “outwardly” refer to directions toward and away from the parts referenced in the drawings. “Axially” refers to a direction along the axis of a shaft. “Radially” refers to a direction normal to an axis. A reference to a list of items that are cited as, for example, “at least one of a or b” (where a and b represent the items being listed) means any single one of the items a or b, or a combination of a and b thereof. This would also apply to lists of three or more items in like manner so that individual ones of the items or combinations thereof are included. The terms “about” and “approximately” encompass +or −10% of an indicated value unless otherwise noted. The terminology includes the words specifically noted above, derivatives thereof and words of similar import. The term “electric motor” or “emotor” is used generically to refer to an electric motor and/or generator.

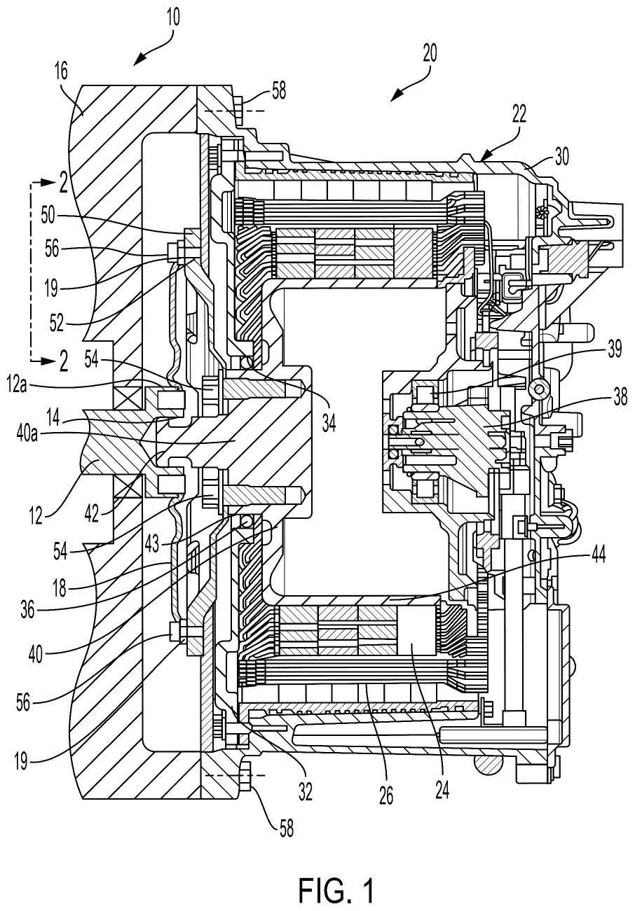

Referring to FIG. 1, an emotor mounting arrangement 20 for an internal combustion engine 10 having a crankshaft 12 is shown in cross-section. The internal combustion engine 10 includes the crankshaft 12, having a piloting bore 14 in one end 12a, being rotatably supported by the engine block 16. Power transfer from the crankshaft 12 can be via a flex plate 18 connected to an end of the crankshaft 12, for example via bolts as shown.

The emotor mounting arrangement 20 further includes an emotor 22 having a rotor 24 that is rotatably mounted for rotation within a stator 26, with the stator 26 being fixed relative to the engine 12. As shown in FIG. 1, the emotor 22 includes an emotor housing 30 which receives the stator 26 and the rotor 24, as well as a front cover 32 that encloses a front of the emotor housing 30. A hub 40 is connected to the rotor 24, with the hub 40 including a pilot extension 42 that is adapted to be supported in the end 12a of the crankshaft 12 of the internal combustion engine 10. While this is shown as a sliding support, it is also possible to use a sliding bearing or needle bearing in connection with supporting the pilot extension 42 within the piloting bore 14.

As illustrated in FIG. 1, the hub 40 can be a cast metal part with an integral rotor carrier 44 on which the rotor 24 is supported. However, as explained in further detail below, alternate arrangements for the hub 40 can be provided.

As illustrated in FIG. 1, the hub 40 can be supported at the opposite end from the crankshaft 12 via a housing support 38 and bearing 39.

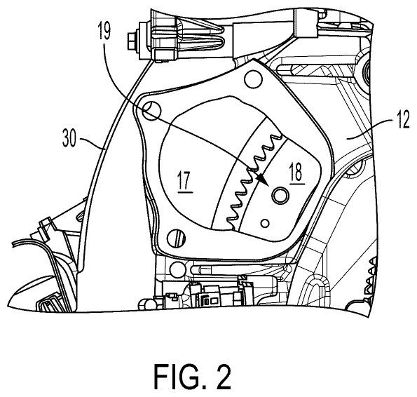

In order to transfer drive torque to and/or from the emotor 20, a drive plate 50 is connected to and extends radially from the hub 40. The drive plate 50 includes connector openings 52 that are adapted for connecting the drive plate 50 to the flex plate 18 connected to the crankshaft 12. In the illustrated embodiment, the drive plate 50 is a stamped sheet metal part and is bolted to the hub 40, for example, via bolts 54. In the illustrated embodiment, the connector openings 52 in the drive plate 50 are threaded and are adapted to receive fasteners 56 that are inserted through corresponding openings 19 in the flex plate 18 in order to allow assembly of the emotor 22 to the engine 10. Access for installing the fasteners 56 can be through a starter motor pocket 17 or other access opening on the engine side of the generator housing 30, for example as shown in FIG. 2. Alternatively, an access opening could be provided through the generator housing 30.

Still with reference to FIG. 1, the front cover 32 that encloses the front of the emotor housing 30 includes an opening 34 through which a front portion 40a of the hub 40 extends. The front portion 40a of the hub 40 includes a circumferentially extending outer surface 43. A seal 36 is located between the front cover 32 and the circumferentially extending outer surface 43. The seal 36 can be a lip seal as illustrated. However, other types of seals could also be used.

This emotor mounting arrangement 20 allows for easy assembly of the emotor 22 to the engine 10 by inserting the pilot extension 42 of the hub 40 that is connected to the rotor 24 into the piloting bore 14 while aligning the connector openings 52 of the drive plate 50 that is connected to and extends radially from the hub 40 with the corresponding openings 19 in the flex plate 18. The fasteners 56 can then be installed through the corresponding openings 19 in the flex plate 18 and into the connector openings 52 in order to connect the drive plate 50 to the flex plate 18. The fasteners 56 may be installed through the starter motor cutout 17 (see FIG. 2), similar to the typical installation of an automatic transmission and torque converter set up. As shown in FIG. 1, the emotor housing 30 is also bolted to the engine block 12 via bolts 58, indicated schematically. This arrangement allows the hub 40 and emotor rotor 24 to be centered via the pilot extension 42 being received in the piloting bore 14 of the crankshaft 12 which allows for easier mounting of the emotor.

He emotor mounting arrangement 20 can be used in connection with a generator arrangement where the engine 10 drives the emotor 22 to generate electricity. It could also be used in a hybrid drive arrangement as a motor/generator.

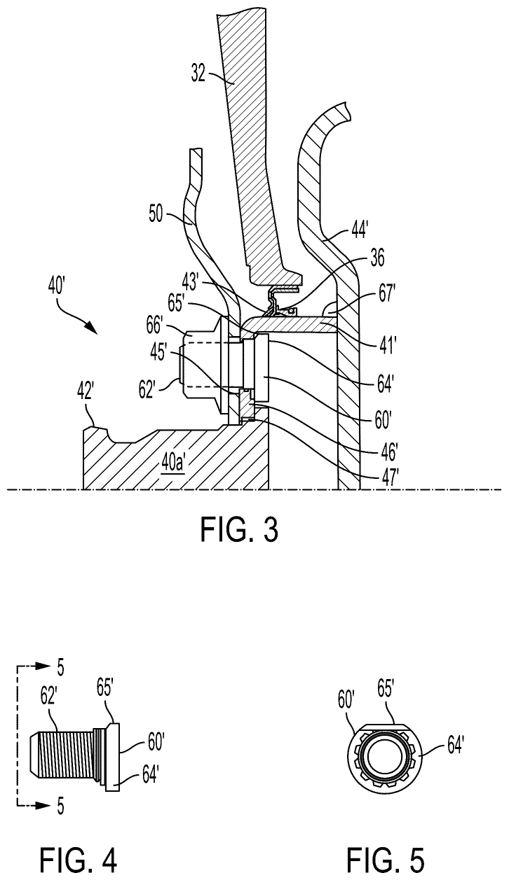

Referring now to FIG. 3, an alternate embodiment of the hub 40′is shown which can be used in connection with the emotor mounting arrangement 20. Here, the hub 40′includes a stamped sheet metal cup 41′that is connected to a rotor carrier 44′, similar to the rotor carrier 44 above, which supports the rotor 24. A plurality of circumferentially spaced stud openings 45′are provided through an end wall 46′of the stamped metal cup 41′. Studs 60′extend through the stud openings 45′with a threaded end 62′of each of the studs 60′extending out from the stud openings 45′. A central opening 47′is provided through the end wall 46′and a front part 40a′ of the hub 40′having the pilot extension 42′extends through the central opening 47′. Here, the front part 40a′ is similar to the front portion 40a of the hub 40 in the first embodiment as described above. However, the front part 40a′ of the hub 40′ with the pilot extension 42′can be machined and/or cold formed as a separate part and then be press-fit into the central opening 47′of the stamped sheet metal cup 41′.

In this arrangement, the studs 60′preferably each include a head 64′that is located inside the stamped sheet metal cup 41′. The heads 64′seat against the inner surface of the end wall 46′which provides positive locating of the studs 60′. Preferably, the studs 60′are press-fit into the stud openings 45′. As shown in detail in FIGS. 4 and 5, the studs 60′may include a flat surface 65′on the head 64′. The flat surface 65′ can be used as an anti-rotation feature and also allows the studs 60′ to be located further radially outwardly within the sheet metal cup 41′. In one embodiment, eight of the studs 60′are used and are equally spaced apart in a circumferential direction. However, the number of studs 60′that are used for the connection depends upon the particular application and the expected torque to be transmitted.

Still with reference to FIG. 3, the drive plate 50 can be fastened to the hub 40′via the studs 60′, for example with nuts 66′ as shown.

As discussed above in connection with the first embodiment, the front part 40a′ of the hub 40′ that includes the pilot extension 42′ extends through the opening 34 in a similar manner to the front portion 40a of the hub 40 described above in connection with the first embodiment. In the second embodiment, the front part 40a′ of the hub 40′includes a circumferentially extending outer surface 43′and the seal 36, as discussed above, is located between the front cover 32 and the circumferentially extending outer surface 43′of the hub 40′.

Still with refence to FIG. 2, the stamped sheet metal cup 41′can be welded (see weld 67′ in FIG. 3) to the rotor carrier 44′. However, other attachment methods can be used.

With this assembly of the hub 40′from stamped sheet metal parts, a cost savings can be achieved in comparison to a hub formed as a cast metal part.

The hub 40′including the metal cup 41′, the stud 60′as well as the front part 40a′ can be assembled in a press prior to welding on the rotor carrier 44′. Providing the flat surface or clipped edge 65′on the studs 60′allows the studs 60′to be located closer to the radially outer surface of the stamped metal cup 41′allowing for transfer of higher torque. This flat 65′also acts as a secondary anti-rotation feature for the studs during attachment of the drive plate 50.

In another aspect a method of connecting an emotor 22 to an internal combustion engine 10 is provided. The emotor 22 has the rotor 24 that is rotatably mounted in the stator 26, that is adapted to be fixed relative to the engine 10, and the rotor 24 is supported via the hub 40, 40′as described above. The method includes inserting the pilot extension 42, 42′of the hub 40, 40′into the piloting bore 14 in the end of the crankshaft 12 and aligning the connector openings 52 of the drive plate 50 that is connected to and extends radially from the hub 40, 40′with the corresponding openings 19 in the flex plate 18. The method then includes installing fasteners 56 in the connector openings 52 in the corresponding openings 19 to connect the drive plate 50 to the flex plate 18.

The method may further include connecting the emotor housing 32 a block 16 of the engine 10, for example using the bolts 58.

The method may further include one or more of the features described above in connection with the hubs 40, 40′.

Further, in each case the seal 36 may be installed between the front cover 32 and the circumferentially extending outer wall 43, 43′of the hub 40, 40′ in order to seal the emotor 22.

Having thus described the presently preferred embodiments in detail, it is to be appreciated and will be apparent to those skilled in the art that many physical changes, only a few of which are exemplified in the detailed description, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiments and optional configurations are therefore to be considered in all respects as exemplary and/or illustrative and not restrictive, the scope that is indicated by the appended claims rather than by the foregoing description, and all alternate embodiments and changes to this embodiment which come within the meaning and range of equivalency of said claims are therefore to be embraced therein.

### LIST OF REFERENCE SYMBOLS

10 internal combustion engine
12 crankshaft
12a end of 12
14 piloting bore
16 engine block
17 starter motor pocket
18 flex plate
19 corresponding openings
20 emotor mounting arrangement
22 emotor
24 rotor
26 stator
30 emotor housing
32 front cover
34 opening
36 seal
38 housing support
39 bearing
40, 40′ hub
40a front portion
40a′ front part
41′ stamped sheet metal cup
42, 42′ pilot extension
43, 43′ circumferentially extending outer surface
44, 44′ rotor carrier
45′ stud openings
46′ end wall
47′ central opening
50 drive plate
52 connector openings
54 bolts
56 fasteners
58 bolts
60′ stud
62′ threaded end
64′ head
65′ flat surface
66′ nut

1. An emotor mounting arrangement to an internal combustion engine having a crankshaft, the emotor mounting arrangement comprising:
an emotor having a rotor that is rotatably mounted and a stator that is fixed relative to the engine;
a hub connected to the rotor, the hub including a pilot extension that is adapted to be supported in an end of a crankshaft of the internal combustion engine;
a drive plate connected to and extending radially from the hub, the drive plate including connector openings adapted for connecting the drive plate to a flex plate connected to the crankshaft.

2. The emotor mounting arrangement of claim 1, wherein the drive plate is a stamped sheet metal part and is bolted to the hub.

3. The emotor mounting arrangement of claim 1, wherein the hub is a cast metal part.

4. The emotor mounting arrangement of claim 1, wherein the connector openings in the drive plate are threaded and are adapted to receive fasteners that are inserted through corresponding openings in the flex plate.

5. The emotor mounting arrangement of claim 1, further comprising an emotor housing which receives the stator and the rotor, and a front cover that encloses a front of the emotor housing and includes an opening through which a front portion of the hub extends, and the front portion of the hub includes a circumferentially extending outer surface, and a seal is located between the front cover and the circumferentially extending outer surface.

6. The emotor mounting arrangement of claim 1, wherein the hub includes a stamped sheet metal cup that is connected to a rotor carrier, a plurality of circumferentially spaced stud openings through an end wall of the stamped metal cup, studs that extend through the stud openings with a threaded end of each of the studs extending out from the stud openings, and a central opening through the end wall, with a front part of the hub having the pilot extension extending through the central opening.

7. The emotor mounting arrangement of claim 6, wherein the studs each include a head that is located inside the stamped sheet metal cup.

8. The emotor mounting arrangement of claim 6, wherein the drive plate is fastened to the hub via the studs.

9. The emotor mounting arrangement of claim 6, wherein the front part of the hub having the pilot extension is cold formed as a separate part and press-fit into the central opening of the stamped sheet metal cup.

10. The emotor mounting arrangement of claim 6, further comprising an emotor housing which receives the stator and the rotor, and a front cover that encloses a front of the emotor housing and includes an opening through which a front part of the hub that includes the pilot extension extends, and the front part of the hub includes a circumferentially extending outer surface, and a seal is located between the front cover and the circumferentially extending outer surface.

11. The emotor mounting arrangement of claim 6, wherein the stamped sheet metal cup is welded to the rotor carrier.

12. A method of connecting an emotor to an internal combustion engine having a crankshaft with a piloting bore in an end and a flex plate connected to the crankshaft at the end, the method comprising:
providing an emotor having a rotor that is rotatably mounted and a stator that is adapted to be fixed relative to the engine;
inserting a pilot extension of a hub connected to the rotor into the piloting bore;
aligning connector openings of a drive plate connected to and extending radially from the hub with corresponding openings in the flex plate; and
installing fasteners in the connector openings and corresponding openings to connect the drive plate to the flex plate.

13. The method of claim 12, wherein the emotor includes an emotor housing which receives the stator and the rotor, and a front cover that encloses a front of the emotor housing and includes an opening through which a front portion of the hub extends, and the front portion of the hub includes a circumferentially extending outer surface, and the method further includes installing a seal between the front cover and the circumferentially extending outer surface.

14. The method of claim 13, wherein the method further includes connecting the emotor housing to a block of the engine.

15. The method of claim 12, wherein the connector openings in the drive plate are threaded, and the method includes inserting the fasteners through the corresponding openings in the flex plate and threadedly engaging the fasteners in the threaded connector openings in the drive plate.

16. The method of claim 12, wherein the method further includes forming the hub from a stamped sheet metal cup that is connected to a rotor carrier for the rotor, and including a plurality of circumferentially spaced stud openings through an end wall of the stamped cup, having studs that extend through the stud openings with a threaded end of each of the studs extending out from the stud openings, and a central opening through the end wall, with a front part of the hub having the pilot extension extending through the central opening, and the drive plate being fastened to the hub via the studs.

17. The method of claim 16, wherein the emotor includes an emotor housing which receives the stator and the rotor, and a front cover that encloses a front of the emotor housing and includes an opening through which the front part of the hub extends, and the front part of the hub includes a circumferentially extending outer surface, and the method further includes installing a seal between the front cover and the circumferentially extending outer surface.
